(19) United States
(12) Patent Application Publication
(10) Pub. No.: US 2002/0164208 A1
(43) Pub. Date: Nov. 7, 2002

(54) Connecting element for connecting two tubes or for closing an end of a tube

(75) Inventor: Hans-Joachim Koellner, Duesseldorf (DE)

Correspondence Address: CROWELL & MORING LLP, INTELLECTUAL PROPERTY GROUP, P.O. BOX 14300, WASHINGTON, DC, 20044-4300, US

(73) Assignee: Wenko-Wenselaar GmbH & Co. KG, Hilden (DE)

(21) Appl. No.: 10/139,753

(22) Filed: May 7, 2002

(30) Foreign Application Priority Data
May 7, 2001 (DE) 201 07 695.0

(51) Int. Cl. F16B 7/00

(52) U.S. Cl. 403/378; 403/292; 403/347

(57) ABSTRACT

A connecting element (2) for joining at least two tubes (10) and/or sealing at least one tube end. The connecting element (2) can be joined to the corresponding tube (10) via a mortise and tenon joint (4, 6) or the like. The tenon (4) is preferably provided on the connecting element and the mortise (6) on the tube (10). The tube (10) is preferably hollow, at least in sections and at least in the area of the junction with the connecting element (2), and the connecting element (2) can be inserted into the tube (10).

### BACKGROUND OF THE INVENTION

The invention relates to a connecting element for joining at least two tubes and/or sealing at least one tube end.

Connecting elements of this type are known in the art. They are typically inserted into the tube ends. If the outer size of the connecting element is too large compared to the inside diameter of a tube, problems arise when the connecting element is joined to the corresponding tube ends. If on the other hand the connecting element is too small compared to the inside diameter of the tube ends, it is easier to assemble but there is a risk that the connecting elements and the tube ends will come apart.

### SUMMARY OF THE INVENTION

The object of the invention is to obviate the aforementioned drawbacks.

This object is achieved by the fact that the connecting element can be connected with the corresponding tube by means of a mortise and tenon joint. The tenon is preferably provided on the connecting element and the mortise on the tube, the tube is preferably hollow at least in the area of the joint with the connecting element and at least in sections, and the connecting element can be inserted into the tube.

The connecting element is inserted into a preferably hollow tube end. It is recommended that the outer dimensions of the connecting element are slightly smaller than the inside diameter of the tube, which is preferably a hollow cylinder. This makes it easy to insert the connecting element into the corresponding tube end. A firm connection is achieved by the mortise and tenon joint, which effectively prevents the connecting element from slipping out of the corresponding tube end. Depending on the configuration of the mortise and tenon joint, the connecting element can be removed again from the tube end by separating the connection. According to the invention, the tenon is preferably provided on the connecting element and the mortise on the tube. However, precisely the opposite arrangement is also possible according to the invention.

In accordance with a preferred embodiment of the invention, the tenon on the connecting element is at least approximately round or angular to interact with a corresponding recess on the tube. In this case, the recess on the tube is preferably slightly larger than the tenon on the connecting element.

If the tenon is round, it is advisable to provide a circular recess in the outer wall of the tube, which is preferably a hollow cylinder.

To facilitate assembly of the connecting element and the tube, it is advantageous if the recess on the tube is slightly larger than the tenon on the connecting element.

In accordance with another preferred embodiment of the invention, the tube has an indentation, which is directed inwardly from its outer edge and interacts with a pocket-like recess on the connecting element. The outer boundary of the indentation is preferably at least approximately cylindrical. This reinforces the hold of the joint between the connecting element and the tube and effectively prevents the connecting element from slipping relative to the tube.

The outer boundary of the indentation can of course have any other geometric shape as well. It is merely advantageous if the pocket-like recess has at least approximately the same geometric form as the outer boundary of the indentation.

In accordance with yet another preferred embodiment of the invention, the connecting element is not a solid body and is preferably made flexible at least in sections, preferably in the area, which when assembled, interacts with a tube. As a result, when the connecting element and the tube are being joined, the connecting element yields slightly to facilitate insertion. When the connecting element and the tube are assembled, the connecting element resumes its original shape, so that the connecting element is prevented from slipping out of the tube. Such a connecting element can, for example, be produced by injection molding.

Production by injection molding has the further advantage that it is relatively cost-effective, so that the production costs of such a connecting element can be greatly reduced.

The connecting element can have various shapes. It can, for instance, be curved or T-shaped. The outer form of the connecting element should be adapted to the corresponding use of the connecting element in the assembled state. For instance, to connect two tubes which will essentially form a right angle, it is advantageous to use a connecting element whose two free end parts for receiving the tubes also form an approximately 90° angle.

To connect three tubes, a T-shaped connecting element is advantageous since three free ends are then available to receive tubes.

Any other embodiment is of course also feasible. The connecting element can, for instance, have any number of free ends for receiving tubes.

In still another preferred embodiment of the invention, precise positioning of the connecting element is achieved by providing the connecting element with a bulge in the area behind the tenon, which faces away from its end. This bulge preferably encircles the connecting element in the form of a ring at least in sections. The connecting element can preferably be inserted into the tube up to the bulge and particularly the outer boundary of the bulge has a greater diameter than the inside diameter of the tube, at least in sections. This prevents the connecting element from slipping too far into the corresponding tube end.

Also, to prevent the connecting element from accidentally slipping into the end of the tube, or from being inserted too far, the connecting element can be provided with a rubber coating or the like in the area that interacts with the outer end of the tube when the connecting element and the tube are assembled.

According to the invention, a stable embodiment of the connecting element and cost-effective production are achieved at the same time if the connecting element is made from synthetic resin material (i.e., plastic), preferably polypropylene. Of course, the connecting element can be made of any other material of sufficient strength, e.g. metal.

The invention further relates to an article of furniture comprising at least two tubes embodied as a modular assembly system.

In accordance with the invention, when the article of furniture is assembled, the tubes are joined by a connecting element with the aid of a mortise and tenon joint or the like. The tenon is preferably provided on the connecting element and the mortise on the tube. The tube is preferably hollow at least in sections and at least in the area of the joint with the connecting element, and the connecting element is inserted into the tubes.

The connecting element can have any of the advantageous configurations described above.

The article of furniture can be embodied, for instance, as a towel holder. Prior art towel holders also include connecting elements that are provided for joining the individual tubes. The prior art connecting elements, however, have screws which must be tightened after assembly. This type of connecting elements must be produced with extremely tight tolerances to ensure that the tubes are securely fixed to one another. This implies higher production costs and makes assembly more difficult.

In the connecting element according to the invention, small tolerances can be compensated so that for this reason alone the production requirements are not as stringent.

In accordance with a preferred embodiment of the article of furniture of the invention, the towel holder preferably is equipped with tubular cross bars for holding towels or the like, and longitudinal tubular bars are connected to the cross bars by connecting elements.

A further embodiment provides that the connecting element between two tubular bars is curved and preferably forms the outer boundary of the towel holder, at least in sections.

It is further advantageous according to the invention if the connecting element between three tubular bars is T-shaped.

An advantageous embodiment of the article of furniture in the form of a towel holder provides that the towel holder has hook-shaped fastening devices for fixing the towel holder to a shower door or the like. The towel holder can be hung over a shower door without requiring any additional fastening means or any screwed connection.

In another advantageous embodiment the towel holder is provided with at least one spacer foot, preferably with a suction cup, to support the towel holder against a door or the like. As a result, the tubes provided for holding towels do not directly contact the door, etc. to which the towel holder is fixed, so that there is sufficient room to hang the towels over the tubular cross bar while ensuring adequate air circulation to dry them.

### BRIEF DESCRIPTION OF THE DRAWINGS

The invention will now be described in greater detail with reference to illustrative preferred embodiments shown in the accompanying drawings, in which:

FIG. 1 is a side view of a connecting element according to the invention;

FIG. 2 is a further view of the connecting element according to FIG. 1;

FIG. 3 is another side view of the connecting element according to FIGS. 1 and 2;

FIG. 4 shows a tube end for receiving a connecting element;

FIG. 5 is a perspective view of a connecting element for receiving a tube according to FIG. 4;

FIG. 6 is a perspective view of the tube according to FIG. 4;

FIG. 7 shows a T-shaped connecting element;

FIG. 8 is a side view of the connecting element depicted in FIG. 7;

FIG. 9 is a further view of the connecting element depicted in FIGS. 7 and 8;

FIG. 10 is a perspective view of the connecting element according to FIGS. 7 to 9;

FIG. 11 shows an article of furniture in the form of a towel holder, and

FIG. 12 is another embodiment of the towel holder.

In the drawings, like components, or components with like function, are identified by the same reference numerals.

### DETAILED DESCRIPTION OF PREFERRED EMBODIMENTS

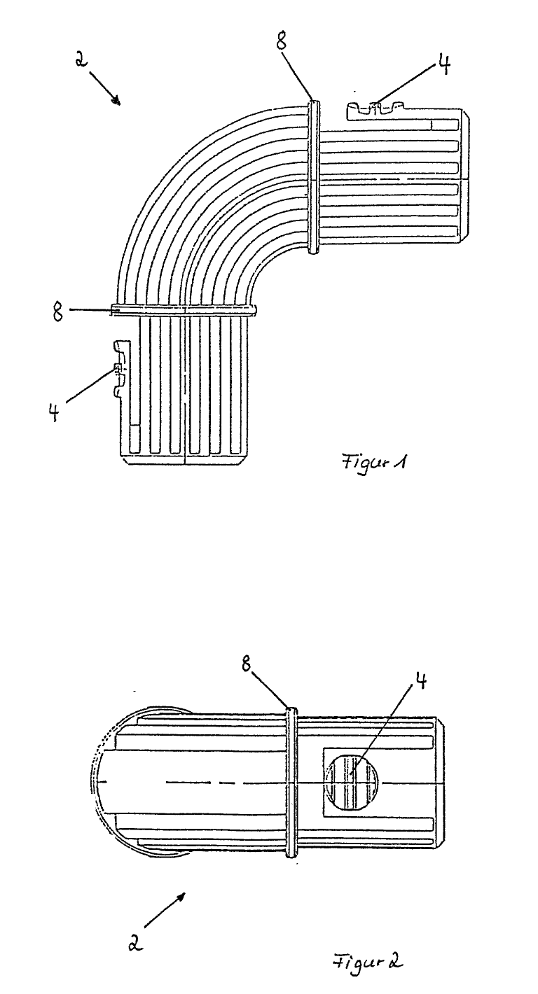

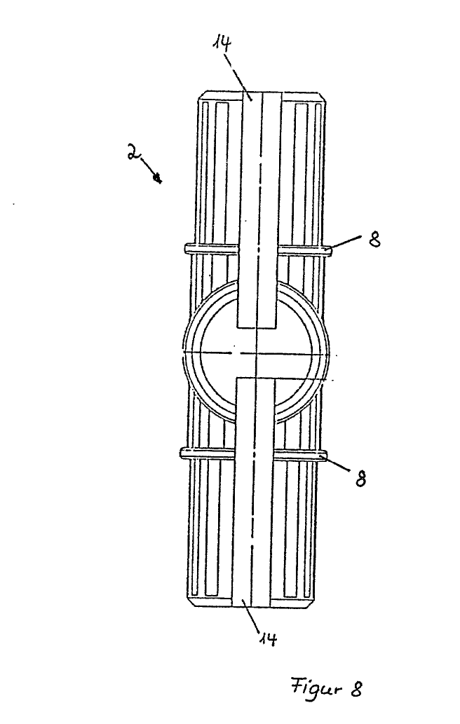

FIG. 1 shows a connecting element 2 for joining two tubes 10 (not shown). The connecting element 2 is curved or L-shaped, and each of its end areas can be inserted into a hollow tube. In the area of the connecting element 2 that interacts with the tube 10, a tenon 4 is provided to interact with a corresponding recess or aperture 6 (cf. FIG. 6) of a tube 10. Once the connecting element 2 is inserted into a tube 10, this mortise and tenon joint 4, 6 prevents it from accidentally slipping out.

In its area behind the tenon 4, the connecting element 2 is provided with a bulge or rib 8 in the form of a ring which encircles the connecting element 2. This annular bulge 8 has an outside diameter that is larger than the inside diameter of a tube 10 into which the connecting element 2 is to be inserted.

The connecting element 2 is produced by injection molding. The connecting element 2 is therefore not formed as a solid body, but has some areas with recesses or slots, so that as the connecting element 2 is inserted into a tube 10, it can yield in some areas. This has the advantage of achieving a relatively firm interference fit of the connecting element 2 within the tube 10 and, in addition, facilitates insertion of the connecting element 2 into a tube 10.

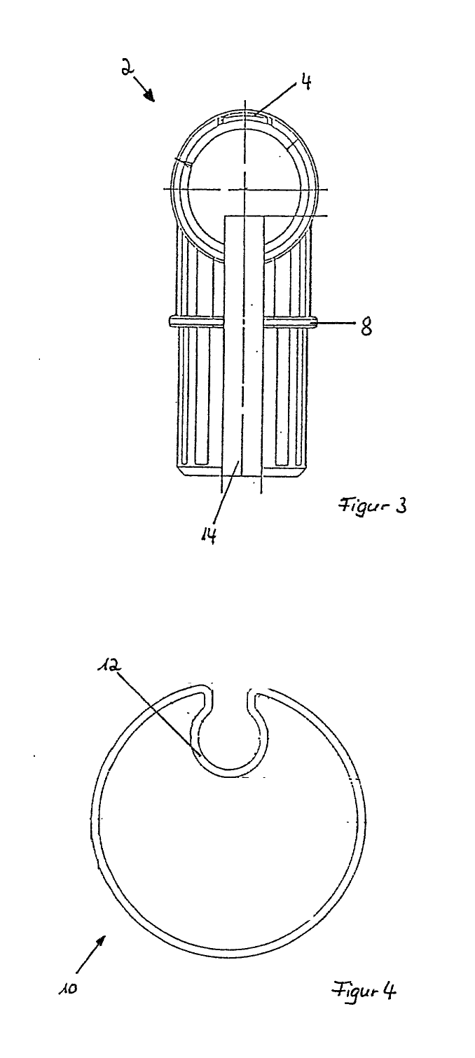

FIG. 2 depicts a top view of the connecting element 2 according to FIG. 1, which shows that the tenon 4 is circular. This circular tenon 4 interacts with a corresponding recess or aperture 6 (cf. FIG. 6) of a tube 10. The inside diameter of the recess or aperture 6 is designed to be slightly larger than the outside diameter of the tenon 4.

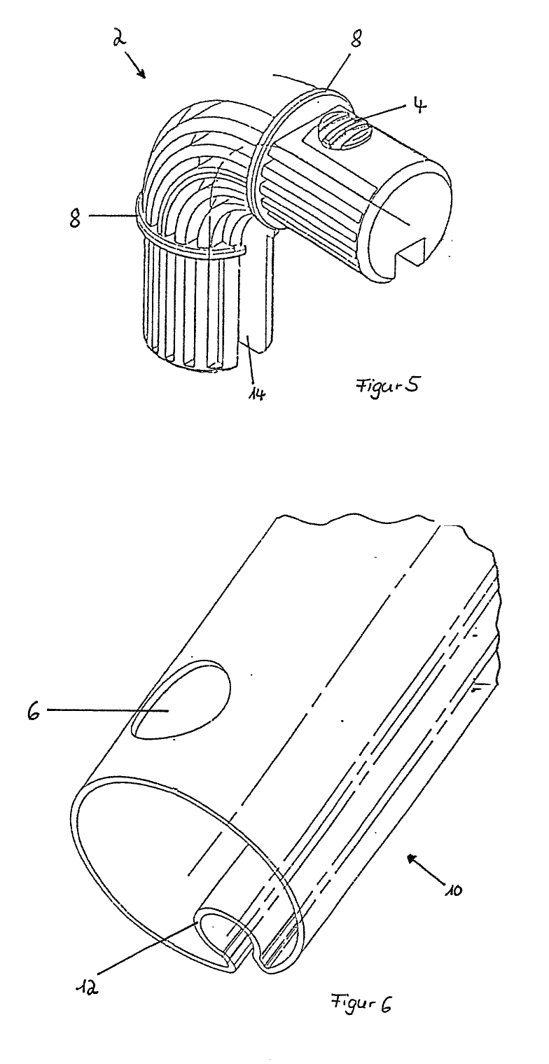

FIG. 3 shows another side view of the connecting element 2. This figure clearly illustrates that the areas of the connecting element 2, which are inserted into the tube 10, are generally cylindrical. In other words, the form of the inserted portions of the connecting element are adapted to the inner form of the tube 10.

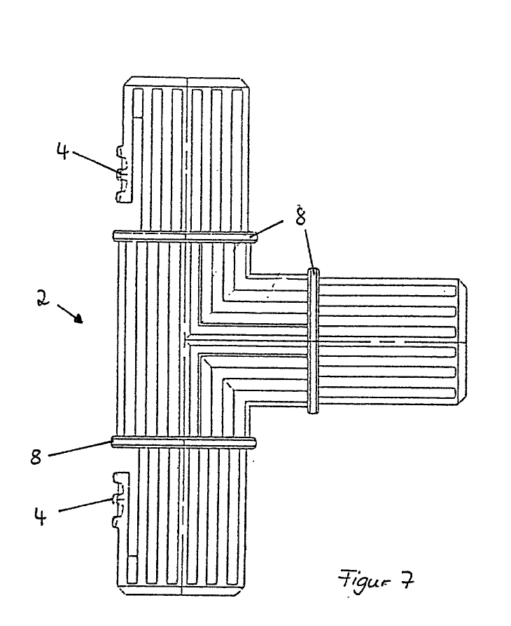

FIG. 4 illustrates an example of a tube 10 into which such a connecting element 2 can be inserted. The tube 10 is made as a hollow cylinder, at least in its end area. A specific feature of this tube 10 is that it has an inwardly directed indentation 12, the outer boundary of which is at least approximately cylindrical. When the connecting element 2 and the tube 10 are assembled, this indentation 12 interacts with a pocket-like recess 14 of the connecting element 2. The pocket-like recess 14 may be clearly seen in FIGS. 3 and 5. Recess 14 is adapted to the outer form of the cylindrical indentation 12. The interaction of this pocket-like recess 14 with the cylindrical indentation 12 of the tube 10 assures precise positioning of the tube 10 on the connecting element 2 to prevent accidental slipping.

FIG. 5 shows a perspective view of the connecting element 2, which is provided with a pocket-like recess 14 for receiving a tube 10 according to FIG. 4. This pocket-like recess 14 extends over the entire inner area of the connecting element 2.

FIG. 6 is a perspective view of the tube 10 according to FIG. 4. This figure clearly shows the circular recess or aperture in the tube 10, which interacts with the tenon 4 of the connecting element 2 to enable the fixation of the connecting element 2 by this mortise and tenon joint 4, 6. The inwardly directed indentation 12 of the tube 10 is arranged on the opposite side of the tube.

The connecting element according to FIGS. 1, 2, 3 and 5 is curved and is used to connect two tubes at an approximately 90° angle.

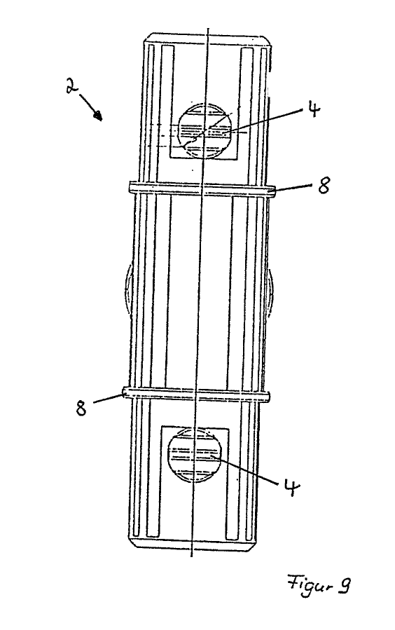

The connecting element 2 according to FIG. 7 has the same functional configuration as the connecting element of the aforementioned figures. It is distinguished merely by the fact that its outer configuration is T-shaped so that it has three free ends to receive three tubes 10.

FIG. 8 shows the same connecting element 2 as FIG. 7, but the view is rotated by 90°. This figure, too, shows pocket-like recesses 14, which are provided to receive the indentations 12 of the tubes 10.

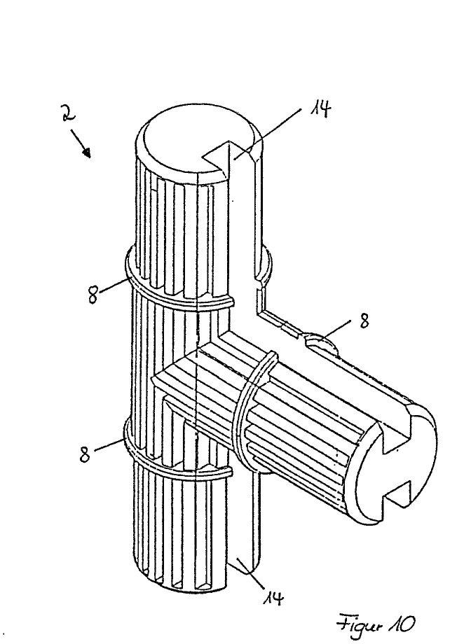

FIG. 9 depicts the same connecting element 2 as FIGS. 7 and 8, but the view is rotated by 180° compared to FIG. 8. This figure also shows that the connecting element 2 is provided with tenons 4, which interact with recesses or apertures 6 of a tube 10. The tube 10 is pushed over the ends of the connecting element 2 until it meets the annular bulge or rib 8.

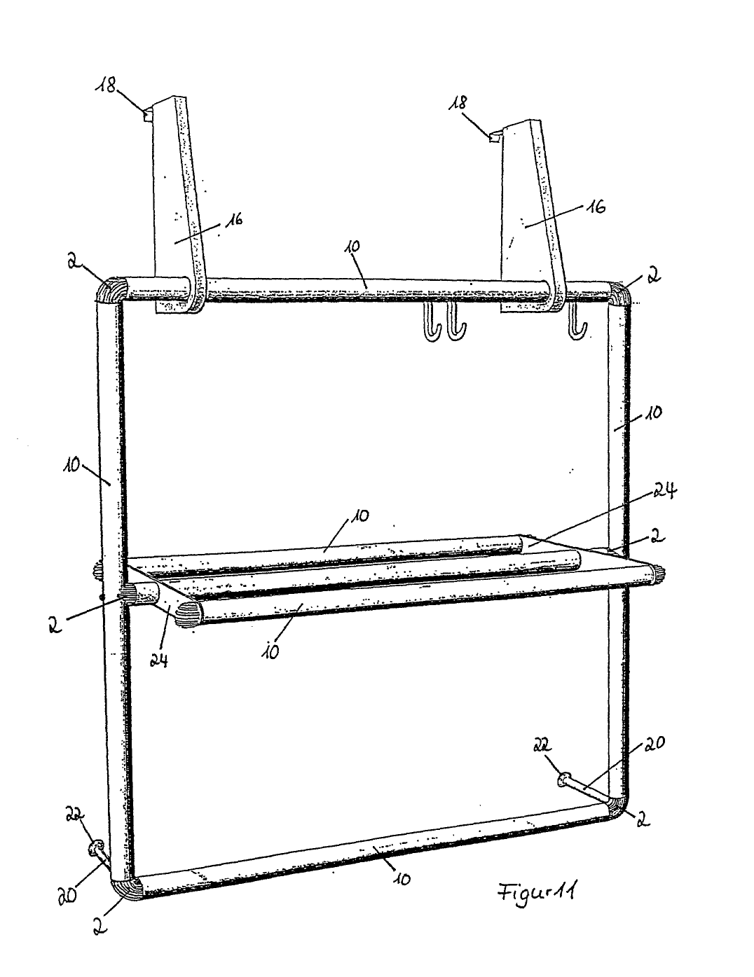

FIG. 10 shows a perspective view of the connecting element 2 according to FIGS. 7 to 9. This figure clearly shows that the pocket-like recesses (14) for receiving the cylindrical indentations (12) of the tube (10) extend over the entire inner side of the connecting element (2).

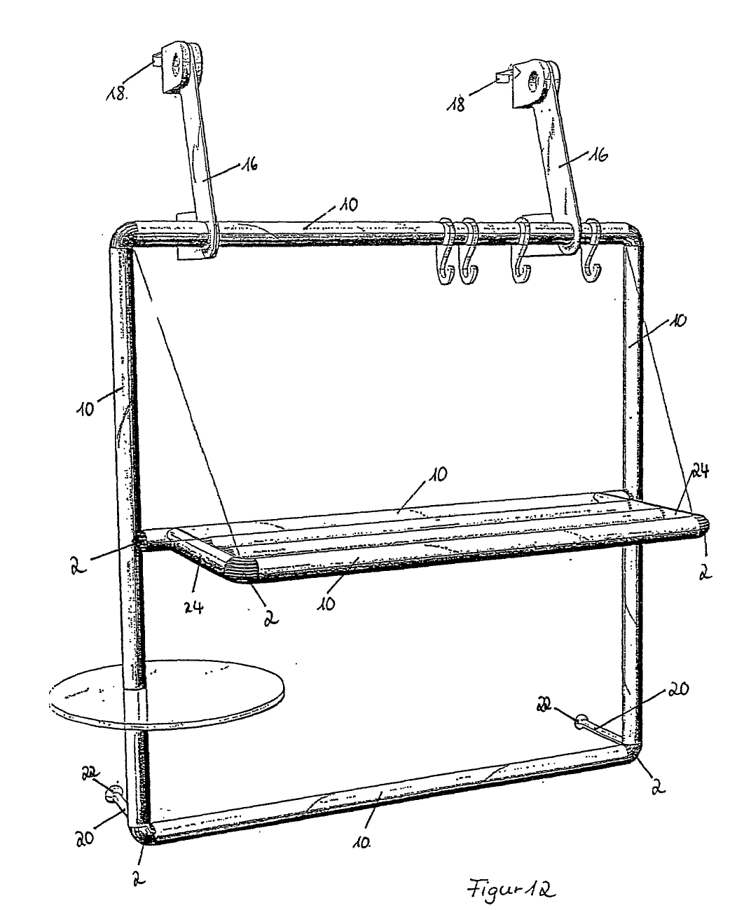

FIG. 11 shows an article of furniture made of tubes 10, which are joined in a modular assembly system. In the corner areas, the tubes are joined by curved connecting elements 2. In the center area, where a towel holder comprised of three tubes 10 is provided, the tubes 10 are joined to the perpendicular side tubes of the towel holder via T-shaped connecting elements 2.

In its upper area, the towel holder has hook-shaped mountng members 16, the ends of which are provided with small hooks 18 that can be hung over a door or a shower door or the like. In its lower area, the towel holder has two spacer feet 20, the ends of which are provided with suction cups 22. These spacer feet 20 are provided to support the towel holder against a door. The suction cups 22 prevent the towel holder from slipping.

The towel holder according to FIG. 12 is constructed similarly to that shown in FIG. 11. Only its mounting members 16 are configured slightly differently, with the upper area designed to swivel relative to the nearly vertical struts of the fastening means 16.

The element intended actually to receive the towels or the like is comprised of four parallel tubes 10 that are interconnected via an outer tube 24. This outer tube 24 is joined to the perpendicular tubes 10 of the towel holder via T-shaped connecting elements 2. FIG. 12 also illustrates how a table member and a plurality of hooks may also be provided at appropriate locations on outer frame tubes 10.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. A connecting element for closing at least one tube end or joining a plurality of tubes, wherein at least end areas of the tube or tubes are hollow; the connecting element has at least one end portion that can be inserted into the hollow end area of a respective tube; and each insertable end portion of the connecting element has a mortise or tenon that can engage a mating tenon or mortise on the respective tube to secure the connecting element to the respective tube.

2. A connecting element according to claim 1, wherein the tenon is provided on the connecting element, and the mortise is provided on the tube.

3. A connecting element according to claim 2, wherein the tenon on the connecting element has an at least substantially round configuration and engages in a circular mortise recess or aperture on the respective tube.

4. A connecting element according to claim 3, wherein the mortise recess or aperture in the respective tube is slightly larger in diameter than the tenon on the connecting element.

5. A connecting element according to claim 1, wherein the insertable end portion of the connecting element is provided with a pocket-like recess for receiving an inwardly directed indentation formed in the respective tube in which the connecting element is to be inserted.

6. A connecting element according to claim 5, wherein said inwardly directed indentation has an at least approximately cylindrical distal contour.

7. A connecting element according to claim 1, wherein the insertable end portions thereof are provided with recesses or slots which facilitate compression of the insertable end portions for insertion into a hollow tube of slightly smaller diameter.

8. A connecting element according to claim 1, wherein the connecting element is an injection molded part.

9. A connecting element according to claim 1, wherein the connecting element is curved or L-shaped.

10. A connecting element according to claim 1, wherein the connecting element is T-shaped.

11. A connecting element according to claim 1, wherein the connecting element has a radially outward bulge adjacent the insertable end portion that limits the depth to which the insertable end portion can be inserted into a respective tube.

12. A connecting element according to claim 11, wherein said radially outward bulge is an annular rib having an outer diameter greater than the inner diameter of the respective tube.

13. A connecting element according to claim 1, wherein the connecting element has a rubber coating in the area, which when assembled, interacts with the outer end of the tube.

14. A connecting element according to claim 1, wherein the connecting element is made of a resilient synthetic resin material.

15. A connecting element according to claim 14, wherein the connecting element is made of polypropylene.

16. An article of furniture comprising a plurality of tubes and connecting elements for closing at least one tube end or joining two or more of said plurality of tubes, wherein at least end areas of the tube or tubes are hollow; said connecting elements each have at least one end portion that can be inserted into the hollow end area of a respective tube; and each insertable end portion of a connecting element has a mortise or tenon that can engage a mating tenon or mortise on the respective tube to secure the connecting element to the respective tube.

17. An article of furniture according to claim 16, wherein the tenon is provided on the connecting element, and the mortise is provided on the respective tube.

18. An article of furniture according to claim 17, wherein the tenon on the connecting element has an at least substantially round configuration and engages in a circular mortise recess or aperture on the respective tube, and the mortise recess or aperture is slightly larger in diameter than the tenon.

19. An article of furniture according to claim 16, wherein each tube has an inwardly directed indentation that is received in a recess in a connecting element inserted therein.

20. An article of furniture according to claim 19, wherein said inwardly directed indentation has an at least approximately cylindrical distal contour.

21. An article of furniture according to claim 16, wherein the insertable end portions of the connecting elements are provided with recesses or slots which facilitate compression of the insertable end portions for insertion into hollow tubes of slightly smaller diameter.

22. An article of furniture according to claim 16, wherein the connecting elements are injection molded parts.

23. An article of furniture according to claim 16, wherein at least one connecting element is curved or L-shaped.

24. An article of furniture according to claim 16, wherein at least one connecting element is T-shaped.

25. An article of furniture according to claim 16, wherein the connecting elements have radially outward bulges adjacent the insertable end portions that limits the depth to which the insertable end portions can be inserted into respective tubes.

26. An article of furniture according to claim 25, wherein said radially outward bulges are annular ribs having an outer diameter greater than the inner diameter of the respective tubes.

27. An article of furniture according to claim 16, wherein the connecting element has a rubber coating in the area, which when assembled with the tube, interacts with the outer end of the tube.

28. An article of furniture according to claim 16, wherein the connecting elements are made of polypropylene.

29. An article of furniture according to claim 16, wherein the article of furniture is a towel holder comprising tubular cross bars for holding towels, said tubular cross bars being connected via the connecting elements with longitudinal tubular bars; wherein connecting elements which join only two tubular bars are curved or L-shaped, and connecting elements which join three tubular bars are T-shaped.

30. An article of furniture according to claim 29, wherein the towel holder is provided with at least one hook-shaped mounting member for mounting the towel holder on a door by hooking the mounting member over an upper edge of the door.

31. An article of furniture according to claim 30, wherein the towel holder further comprises at least one spacer foot for supporting the towel holder against the door.
